(19) United States
(12) Patent Application Publication
(10) Pub. No.: US 2025/0103327 A1
(43) Pub. Date: Mar. 27, 2025

(54) ARCHITECTURE LIFETIME ESTIMATION APPARATUS AND METHOD OF ESTIMATING ARCHITECTURE LIFETIME

(71) Applicant: Mitsubishi Electric Corporation, Chiyoda-ku, Tokyo (JP)

(72) Inventors: Sho KANEKO, Tokyo (JP); Yuki HIKAWA, Tokyo (JP); Masaki FUJITA, Tokyo (JP); Yoshitaka IMOTO, Tokyo (JP)

(73) Assignee: Mitsubishi Electric Corporation, Chiyoda-ku, Tokyo (JP)

(21) Appl. No.: 18/728,320

(22) PCT Filed: Aug. 19, 2022
(86) PCT No.: PCT/JP2022/031302

§ 371 Date: Jul. 11, 2024

(30) Foreign Application Priority Data
Jan. 18, 2022 (JP) 2022-005836

(51) Int. Cl. G06F 8/77

(52) U.S. Cl. CPC G06F 8/77

(57) ABSTRACT

The object is to provide a technique for enabling one to appropriately draw up a guideline for a development project. An architecture lifetime estimation apparatus includes: an age calculator to calculate a diagnosed age of a source code based on software quality data values; a data accumulation unit to accumulate the diagnosed age for each of revisions of the source code; a development trend approximate expression calculator to calculate a development trend approximate expression based on the diagnosed age accumulated by the data accumulation unit for each of the revisions; and a lifetime estimation unit to estimate a lifetime of the source code based on the development trend approximate expression.

### TECHNICAL FIELD

The present disclosure relates to an architecture lifetime estimation apparatus and a method of estimating an architecture lifetime.

### BACKGROUND ART

In recent years, diversion development of software bloats the scale of software and complicates the software structure. Particularly, an increase in the number of revisions for modifying, for example, the maintenance or functional additions in software complicates the software structure. This reduces the quality of software such as usability, maintainability, and portability, and allows no more revision in some cases.

Here, it is important to analyze the complicated software structure and simplify the software structure in consideration of the analyzed result. To assist simplification of the software structure, software analysis techniques for visualizing the current software quality using, for example, graphs have been proposed. For example, Patent Document 1 proposes a technique for calculating a dependency strength weighted according to each dependency between software components, using weight information based on the importance of a dependency type that is a type of a relationship between the software components to visualize the dependency strength.

### PRIOR ART DOCUMENT

### Patent Document

Patent Document 1: Japanese Patent No. 5687122

### SUMMARY

### Problem to be Solved by the Invention

Although the technique of Patent Document 1 calculates software quality such as a dependency strength at a point in time when a source code is input, the technique does not reflect an improved state or a deteriorated state of the software quality through a long-term development period. Thus, developers of source codes each have a problem of not being able to know how much software assets can be used, and a problem with difficulty in appropriately drawing up a guideline for a development project.

The present disclosure has been made in view of the problems, and has an object of providing a technique for enabling one to appropriately draw up a guideline for a development project.

### Means to Solve the Problem

An architecture lifetime estimation apparatus according to the present disclosure includes: an obtaining unit to obtain a source code: a software quality measurement unit to measure software quality data values each indicating quality of the source code, based on the source code; an age calculator to calculate complexity of the source code in a software structure as a diagnosed age of the source code, based on the software quality data values; a data accumulation unit to accumulate the diagnosed age for each of revisions of the source code; a development trend approximate expression calculator to calculate, based on the diagnosed age accumulated by the data accumulation unit for each of the revisions, a development trend approximate expression indicating a relationship between the revision and the diagnosed age; and a lifetime estimation unit to estimate a lifetime on the revision of the source code, based on the development trend approximate expression, wherein the architecture lifetime estimation apparatus outputs information based on the lifetime. The object, features, aspects, and advantages of the present disclosure will become more apparent from the following detailed description and the accompanying drawings.

### Effects of the Invention

According to the present disclosure, a development trend approximate expression is calculated based on a diagnosed age accumulated by the data accumulation unit for each revision, and a lifetime of the source code is estimated based on the development trend approximate expression. Since this configuration estimates the lifetime not for a point in time but for a period of time, a guideline for a development project can be appropriately drawn up.

### BRIEF DESCRIPTION OF DRAWINGS

FIG. 1 is a block diagram illustrating a configuration of an architecture lifetime estimation apparatus according to Embodiment 1.

FIG. 2 illustrates example metrics according to Embodiment 1.

FIG. 3 illustrates an example diagnosed age according to Embodiment 1.

FIG. 4 illustrates example software quality data values according to Embodiment 1.

FIG. 5 illustrates example diagnosed ages according to Embodiment 1.

FIG. 6 illustrates example software quality data values according to Embodiment 1.

FIG. 7 illustrates example diagnosed ages according to Embodiment 1.

FIG. 8 is a block diagram illustrating a configuration of an architecture lifetime estimation apparatus according to Embodiment 2.

FIG. 9 illustrates example metrics according to Embodiment 2.

FIG. 10 illustrates example diagnosed ages according to Embodiment 2.1

FIG. 11 illustrates example software quality data values according to Embodiment 2.

FIG. 12 illustrates example diagnosed ages according to Embodiment 2.

FIG. 13 is a block diagram illustrating a configuration of an architecture lifetime estimation apparatus according to Embodiment 3.

FIG. 14 illustrates example metrics according to Embodiment 3.

FIG. 15 illustrates example diagnosed ages according to Embodiment 3.

FIG. 16 illustrates example dependencies between functional units according to Embodiment 3.

FIG. 17 illustrates example software quality data values according to Embodiment 3.

FIG. 18 illustrates example diagnosed ages according to Embodiment 3.

FIG. 19 is a block diagram illustrating a configuration of an architecture lifetime estimation apparatus according to Embodiment 4.

FIG. 20 illustrates example metrics according to Embodiment 4.

FIG. 21 illustrates example diagnosed ages according to Embodiment 4.

FIG. 22 illustrates proficiency levels of operators according to Embodiment 4.

FIG. 23 illustrates example development prospect information according to Embodiment 4.

FIG. 24 illustrates example operation information according to Embodiment 4.

FIG. 25 illustrates example software quality data values according to Embodiment 4.

FIG. 26 illustrates example diagnosed ages according to Embodiment 4.

FIG. 27 illustrates an example correspondence table between development prospects and age thresholds according to Embodiment 4.

FIG. 28 illustrates an example correspondence table between proficiency values and proficiency levels according to Embodiment 4.

FIG. 29 illustrates an example correspondence table between the proficiency levels and proficiency level coefficients according to Embodiment 4.

FIG. 30 is a block diagram illustrating a configuration of an architecture lifetime estimation apparatus according to Embodiment 5.

FIG. 31 illustrates example metrics according to Embodiment 5.

FIG. 32 illustrates example software quality data values according to Embodiment 5.

FIG. 33 illustrates example software quality data values according to Embodiment 5.

FIG. 34 illustrates example diagnosed ages according to Embodiment 5.

FIG. 35 is a block diagram illustrating a hardware configuration of an architecture lifetime estimation apparatus according to another modification.

FIG. 36 is a block diagram illustrating a hardware configuration of an architecture lifetime estimation apparatus according to another modification.

### DESCRIPTION OF EMBODIMENTS

### Embodiment 1

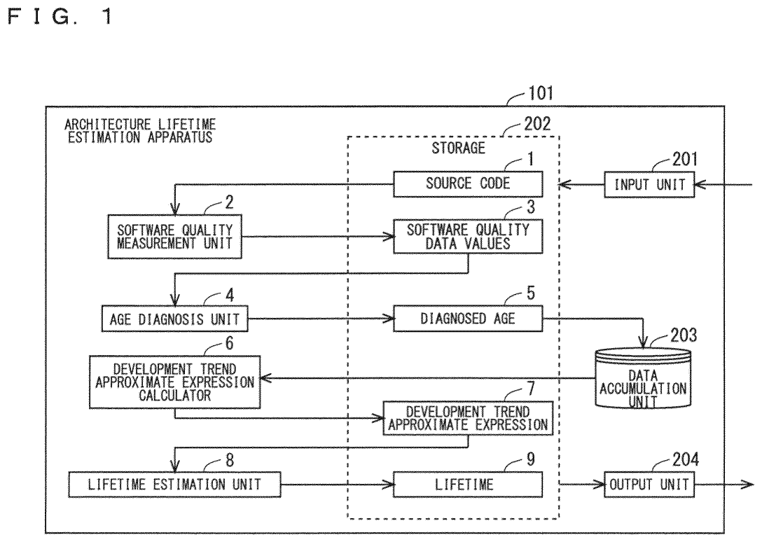

FIG. 1 is a block diagram illustrating a configuration of an architecture lifetime estimation apparatus 101 according to Embodiment 1. The following will describe diversion development of software for generating a source code of a revision 2 using a source code of a revision 1, and diversion development of software for generating a source code of a revision 3 using the source code of the revision 2. The revision means a revision of a source code for modifying, for example, the maintenance or functional additions in software. As the number of revisions increases, the value of the revision becomes larger. The following will describe a case where the architecture lifetime estimation apparatus 101 estimates an architecture lifetime from the source codes of the revisions 1, 2, and 3.

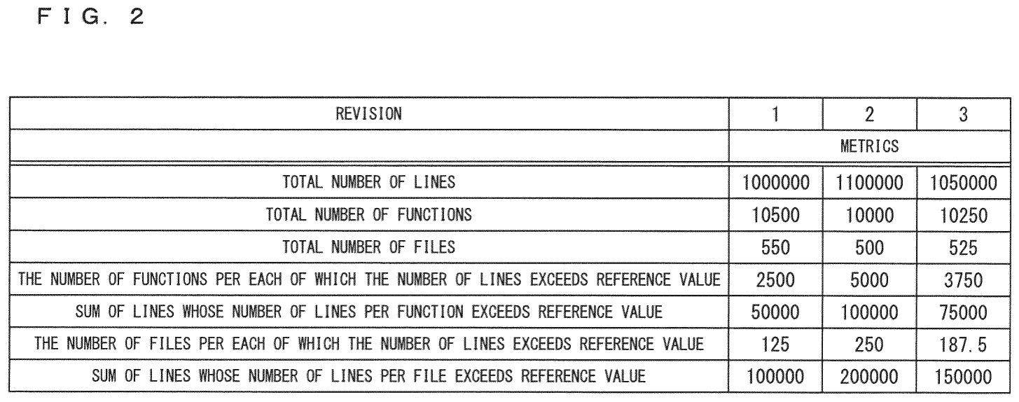

FIG. 2 illustrates example metrics for each of the revisions. The metrics are values for quantitatively evaluating the software quality. Examples of the metrics include the number of lines, the number of functions, cyclomatic complexity, and the number of dependencies.

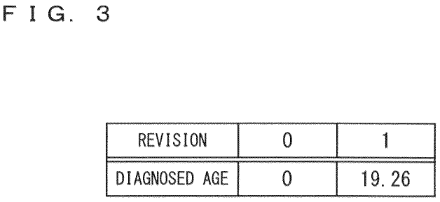

FIG. 3 illustrates an example diagnosed age of the revision 1 which has been calculated by an age diagnosis unit 4 and accumulated by a data accumulation unit 203. Although calculation of a diagnosed age of the revision 2 will be described later, calculation of diagnosed ages of the revision 1 and the revision 3 are identical to that of the revision 2.

Here, the “diagnosed age” ranges values from 0 to infinity. A low diagnosed age, that is, a diagnosed age of a low value indicates that the complexity in a software structure is low and the software quality is good. A high diagnosed age, that is, a diagnosed age of a high value indicates that the complexity in the software structure is high and the software quality is bad. The “lifetime” to be described later is the number of times the source code can be revised, which is estimated based on changes in the accumulated diagnosed ages.

The architecture lifetime estimation apparatus 101 is an apparatus that analyzes the quality and the development trend of software, such as a computer. The architecture lifetime estimation apparatus 101 estimates a lifetime quantified in value (may be referred to as an architecture lifetime) that is available for analyzing the quality and the development trend of software and drawing up a guideline for a development project.

The architecture lifetime estimation apparatus 101 in FIG. 1 includes a software quality measurement unit 2, the age diagnosis unit 4 as an age calculator, a development trend approximate expression calculator 6, a lifetime estimation unit 8, an input unit 201 as an obtaining unit, a storage 202, the data accumulation unit 203, and an output unit 204. The storage 202 is, for example, a memory, and stores a source code 1, software quality data values 3, a diagnosed age 5, a development trend approximate expression 7, and a lifetime 9.

The input unit 201 receives and obtains the source code 1 from, for example, an external device. The storage 202 stores the obtained source code 1. A source code is enumeration of characters as a source of software (s/w) such as a computer program, and defines a series of instructions to a computer.

The software quality measurement unit 2 extracts, from the source code 1, for example, the total number of lines, the total number of functions, and the total number of files as metrics as illustrated in FIG. 2. The metrics are not limited to those in FIG. 2 but may include the number of variables, the number of dependencies, a module strength, module coupling, and cyclomatic complexity.

The software quality measurement unit 2 measures the software quality data values 3 each indicating the quality of the source code, based on the extracted metrics. The software quality data value is a value to be an indicator of an element of software quality data. For example, the software quality measurement unit 2 calculates the software quality data value using Equations (1) to (4).

$$\begin{matrix}[ Math 1 ] & \\ A software quality data value ( the number of functions per each of which the number of lines exceeds a reference value ) = \frac{( the number of functions per each of the which the nunber of lines exceeds the reference value )}{( ( the total number of functions ) - ( the number of functions per each of which the number of lines exceeds the reference value ) )} & ( 1 )\end{matrix}$$

$$\begin{matrix}[ Math 2 ] & \\ A software quality data value ( a sum of lines whose number of lines per function exceeds a reference value ) = \frac{( the sum of lines whose number of lines per function exceed the reference value )}{( ( the total number of lines ) = ( the sum of lines whose number of lines per function exceeds the reference value ) )} & ( 2 )\end{matrix}$$

$$\begin{matrix}[ Math 3 ] & \\ A software quality data value ( the number of files per each of which the number of lines exceeds a reference value ) = \frac{( the number of files per each of which the number of lines exceeds the reference value )}{( ( the total number of files ) - ( the nunber of files per each of which the number of lines exceeds the reference value ) )} & ( 3 )\end{matrix}$$

$$\begin{matrix}[ Math 4 ] & ( 4 ) \\ A software quality data value ( a sum of lines whose number of lines per file exceeds a reference value ) = \frac{( the sum of lines whose number of lines per file exceeds the reference value )}{( ( the total number of lines ) - ( the sum of lines whose number of lines per file exceeds the reference value ) )} & \end{matrix}$$

Equations (1) to (4) use, for example, values requiring refactoring, that is, 100 lines and 2000 lines as the reference value for the number of lines per function and the reference value for the number of lines per file, respectively. Equations (1) to (4) are defined as 0 when the software quality data values indicate the highest quality, and defined to diverge to infinity when the software quality data values indicate the lowest quality.

The equations for calculating the software quality data value are not limited to Equations (1) to (4). For example, an indicator on the number of functions per file or an indicator on cyclomatic complexity may be used as the software quality data value.

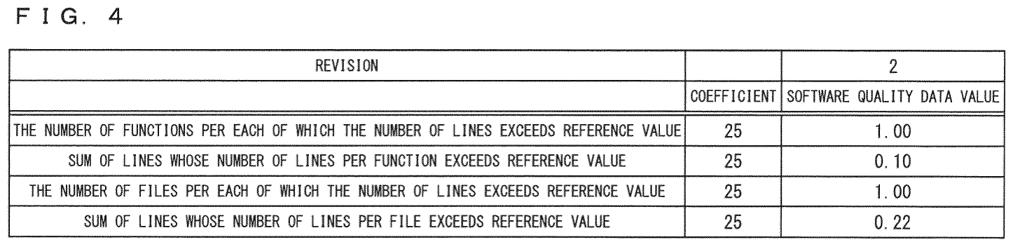

FIG. 4 illustrates example software quality data values, specifically, software quality data values of the revision 2. FIG. 4 indicates software quality data values each measured for an element of the software quality data. FIG. 4 also indicates coefficients each defined for the element of the software quality data. The software quality data values and the coefficients are used when the age diagnosis unit 4 calculates a diagnosed age of a source code, which will be described next.

The coefficients are used for weighting as necessary based on a degree in which

each of the software quality data values influences the diagnosed age, or for adjusting the number of digits of the software quality data value. In the example of FIG. 4, a total of the coefficients of the software quality data values is defined as 100. In the example of FIG. 4, assuming that the four software quality data values equivalently influence the software quality, each of the coefficients of the four software quality data values is defined as 25 obtained by dividing the total of 100 into equal parts for convenience.

The age diagnosis unit 4 calculates the complexity of the source code in a software structure as the diagnosed age 5 of the source code, based on the software quality data values 3 measured by the software quality measurement unit 2. For example, the age diagnosis unit 4 calculates the diagnosed age of the source code, using Equation (5).

$$\begin{matrix}[ Math 5 ] & \\ A diagnosed age = {\sum }_{each software quality data} a coefficient \times a software quality data value & ( 5 )\end{matrix}$$

With the software quality data values in FIG. 4, the age diagnosis unit 4 calculates 58.06 (≈25×(1.00+0.10+1.00+0.22)) as the diagnosed age of the revision 2. The age diagnosis unit 4 stores the calculated diagnosed age in the data accumulation unit 203.

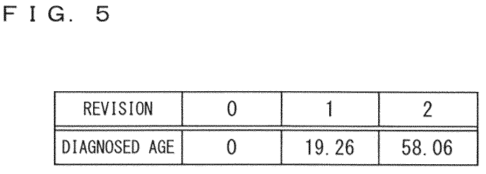

Since the data accumulation unit 203 has already accumulated the diagnosed age of the revision 1 in FIG. 3, storing the diagnosed age of the revision 2 allows the data accumulation unit 203 to accumulate the diagnosed ages of the revisions 1 and 2 as illustrated in FIG. 5. In this manner, the data accumulation unit 203 accumulates the diagnosed age 5 for each revision of the source code.

The development trend approximate expression calculator 6 calculates the development trend approximate expression 7 indicating a relationship between a revision and a diagnosed age, based on the diagnosed age 5 accumulated by the data accumulation unit 203 for each revision. For example, the development trend approximate expression calculator 6 performs a linear approximation such as the least square method on pairs of coordinates (0, 0), (1, 19.26), and (2, 58.06) assuming that the x axis represents a revision and the y axis represents a diagnosed age to calculate y=29.03x−3.26 as the development trend approximate expression 7.

The lifetime estimation unit 8 estimates the lifetime 9 on a revision of the source code, based on the development trend approximate expression 7. The lifetime estimation unit 8, for example, calculates a revision when the diagnosed age of the development trend approximate expression 7 is equal to an age threshold that is a threshold predefined for the diagnosed age, and calculates a lifetime by subtracting the current revision from the calculated revision. In the example above, the lifetime estimation unit 8 calculates 3.56 as a revision satisfying y=100 in y=29.03x−3.26, and calculates 1.56 as a lifetime by subtracting 2 as the current revision from 3.56 as the calculated revision. Although the value calculated in this manner is used as a lifetime, the lifetime is not limited to this. For example, the revision when the diagnosed age of the development trend approximate expression 7 is equal to the age threshold may be used as a lifetime as it is.

The output unit 204 outputs information based on the lifetime 9 estimated by the lifetime estimation unit 8 to, for example, an external device and an operator. The output unit 204 may output, for example, the source code 1, the software quality data values 3, the development trend approximate expression 7, and the lifetime 9, and the diagnosed age 5 accumulated by the data accumulation unit 203.

The data accumulation unit 203 may accumulate various information, similarly to outputting various information by the output unit 204. The data accumulation unit 203 may accumulate, for example, the source code 1, the software quality data values 3, the diagnosed age 5, the development trend approximate expression 7, and the lifetime 9.

The aforementioned operations are performed similarly when the source code of the revision 3 is generated using the source code of the revision 2. The following will describe this case.

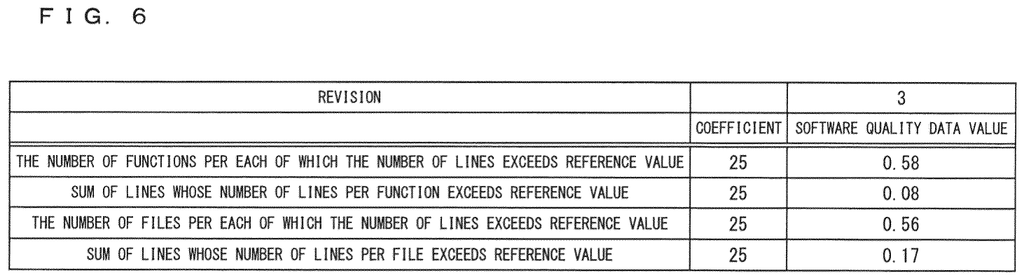

The software quality measurement unit 2 measures the software quality data values 3 each indicating the quality of the source code, based on the extracted metrics. FIG. 6 illustrates example software quality data values, specifically, software quality data values of the revision 3.

The age diagnosis unit 4 calculates the diagnosed age 5, based on the software quality data values 3 measured by the software quality measurement unit 2. With the software quality data values in FIG. 6, the age diagnosis unit 4 calculates 34.40 (≈25×(0.58+0.08+0.56+0.17)) as the diagnosed age of the revision 3.

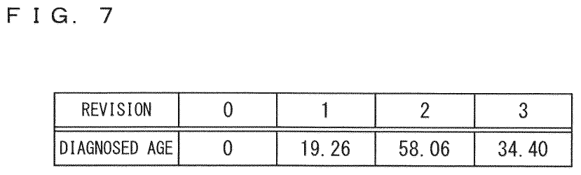

The age diagnosis unit 4 stores the calculated diagnosed age 5 in the data accumulation unit 203. The data accumulation unit 203 accumulates the diagnosed age 5 for each of the revisions of the source code as illustrated in FIG. 7.

The development trend approximate expression calculator 6 calculates the development trend approximate expression 7, based on the diagnosed age 5 accumulated by the data accumulation unit 203 for each of the revisions. For example, the development trend approximate expression calculator 6 performs a linear approximation such as the least square method on pairs of coordinates (0, 0), (1, 19.26), (2, 58.06), and (3, 34.40) to calculate y=14.20x+6.63 as a development trend approximate expression.

The lifetime estimation unit 8 estimates the lifetime 9 on a revision of the source code, based on the development trend approximate expression 7. For example, the lifetime estimation unit 8 calculates 6.58 as a revision satisfying y=100 in y=14.20x+6.63, and calculates 3.58 as a lifetime by subtracting 3 as the current revision from 6.58 as the calculated revision.

Since 3.58 as the lifetime of the revision 3 is larger than 1.56 as the lifetime of the revision 2, it is clear that the architecture of the source code in the revision 3 has been improved.

### Conclusion of Embodiment 1

Since a diagnosed age of a revision at the time of inputting a source code is calculated in Embodiment 1, the quality of the architecture on the current source code can be quantified. Furthermore, a lifetime of the architecture on the source code is estimated based on the diagnosed age accumulated for each revision. Thus, how much the architecture can be used in the future for diversion development and development for functional additions can be quantified not for a point in time or for a period of time. This can facilitate drawing up a guideline for a development project.

### Embodiment 2

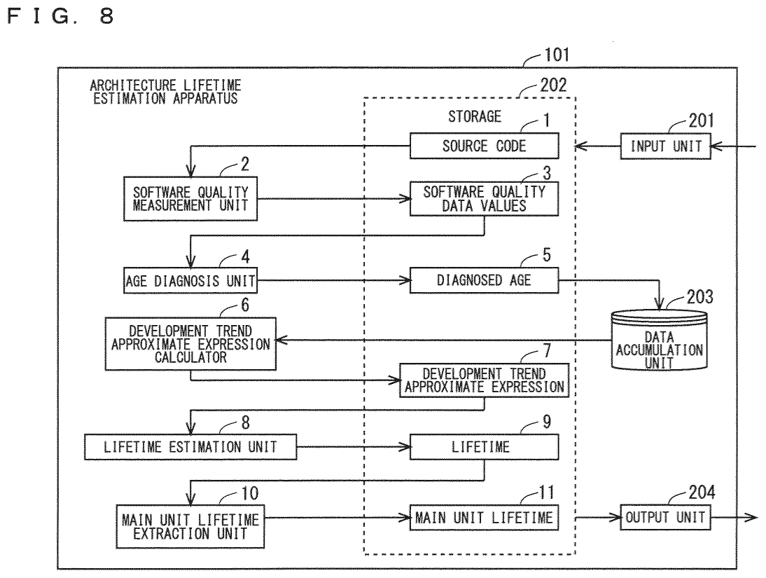

FIG. 8 is a block diagram illustrating a configuration of the architecture lifetime estimation apparatus 101 according to Embodiment 2. Among the constituent elements according to Embodiment 2, the same or similar constituent elements as those described above will have the same or similar reference numerals, and the different constituent elements will be mainly described.

The following will describe a case where the data accumulation unit 203 accumulates the diagnosed age of the revision 1 similarly to Embodiment 1, and the architecture lifetime estimation apparatus 101 estimates an architecture lifetime from the source codes of the revisions 1 and 2.

In Embodiment 1, a lifetime of the whole software, that is, a lifetime of the whole source code is estimated. In contrast, the source code is partitioned per predefined unit and a lifetime is estimated for each of the partitions in Embodiment 2. The predefined unit will be described as a functional unit of software in the following description. The predefined unit is not limited to this but may be, for example, a unit whose revision is necessary.

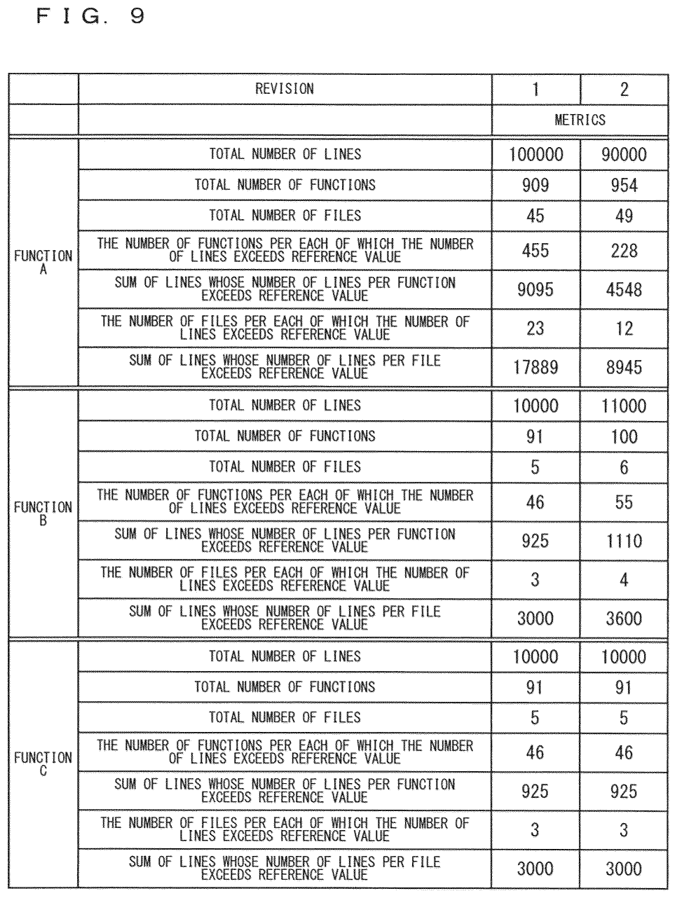

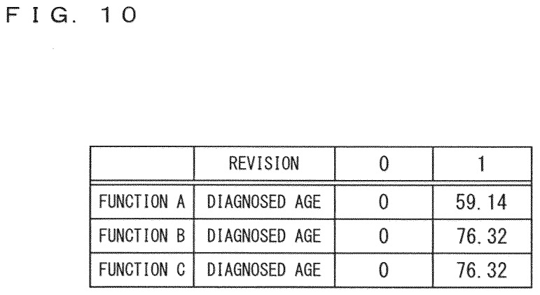

FIG. 9 illustrates example metrics for each of the revisions. FIG. 10 illustrates example diagnosed ages of the revision 1 which have been calculated by the age diagnosis unit 4 and accumulated by the data accumulation unit 203. As illustrated in FIGS. 9 and 10, the source code is partitioned into functional units, namely, functions A, B, and C. The functional units may be defined based on a folder structure. Alternatively, a functional structure definition file in which a functional structure has been defined is received by the input unit 201, stored by the storage 202, and referred to by the software quality measurement unit 2, so that the functional units may be defined.

The architecture lifetime estimation apparatus 101 in FIG. 8 has a configuration in which a main unit lifetime extraction unit 10 has been added to the configuration in FIG. 1. The storage 202 stores a main unit lifetime 11 in addition to the elements stored in FIG. 1.

The software quality measurement unit 2 extracts, from the source code 1, for example, the total number of lines, the total number of functions, and the total number of files as metrics for each of the functional units as illustrated in FIG. 9. The software quality measurement unit 2 measures the software quality data values 3 for each of the functional units, based on the metrics extracted for the functional unit.

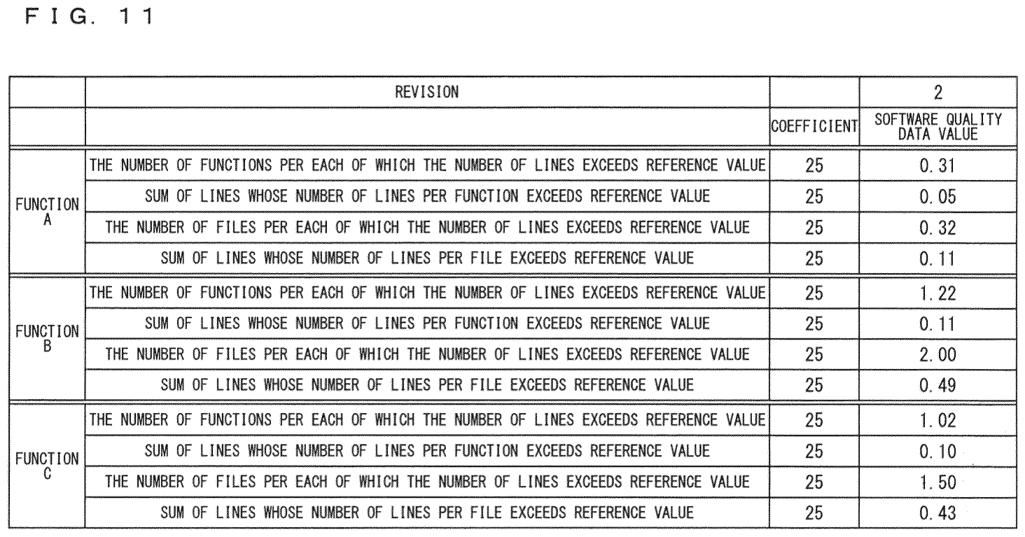

FIG. 11 illustrates example software quality data values, specifically, software quality data values of the revision 2. FIG. 11 indicates software quality data values measured for each of the functional units.

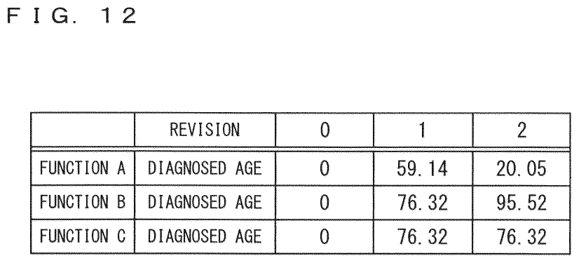

The age diagnosis unit 4 calculates the diagnosed age 5 for each of the functional units, based on the software quality data values 3 measured for the functional unit. The age diagnosis unit 4 stores the diagnosed age 5 calculated for each of the functional units in the data accumulation unit 203. The data accumulation unit 203 accumulates the diagnosed age 5 for each of the revisions of the source code and for each of the functional units as illustrated in FIG. 12.

The development trend approximate expression calculator 6 calculates the development trend approximate expression 7 for each of the functional units, based on the diagnosed age 5 accumulated by the data accumulation unit 203 for each of the revisions and for each of the functional units. For example, the development trend approximate expression calculator 6 performs a linear approximation such as the least square method on the diagnosed age of the function A to calculate y=10.02x+16.37 as a development trend approximate expression of the function A. Similarly, the development trend approximate expression calculator 6 calculates y=47.76x+9.52 as the development trend approximate expression 7 of the function B, and calculates y=38.16x+12.72 as the development trend approximate expression 7 of the function C.

The lifetime estimation unit 8 estimates the lifetime 9 of the source code for each of the functional units, based on the development trend approximate expression 7 calculated for the functional unit. In the example above, the lifetime estimation unit 8 calculates 6.35 as the lifetime of the function A, calculates −0.11 as the lifetime of the function B, and calculates 0.29 as the lifetime of the function C.

The main unit lifetime extraction unit 10 extracts the main unit lifetime 11 that is the lifetime 9 of one functional unit, based on the influence of the lifetime 9 estimated by the lifetime estimation unit 8 for each of the functional units on the lifetime 9 of the whole source code 1. For example, the main unit lifetime extraction unit 10 extracts, as the main unit lifetime, the lifetime of the one functional unit that the most greatly influences the lifetime of the whole source code estimated in Embodiment 1, from among the lifetimes of the functional units. In this example, the main unit lifetime extraction unit 10 first calculates a unit lifetime scale indicating the influence on the lifetime of the whole source code, using Equation (6).

$$\begin{matrix}[ Math 6 ] & \\ A unit lifetime \text{} scale = \vert \text{} a unit lifetime - a whole lifetime \vert \times \frac{the unit number of lines}{the total number of lines} & ( 6 )\end{matrix}$$

Here, the unit lifetime is a lifetime estimated for each of the functional units in Embodiment 2. The whole lifetime is a lifetime of the whole source code estimated in Embodiment 1. The unit number of lines is the total number of lines for each of the functional units in FIG. 9. The total number of lines is a sum of the total number of lines for each of the functional units.

When the whole lifetime calculated similarly to Embodiment 1 is 4.15, the main unit lifetime extraction unit 10 calculates unit lifetime scales of the function A, the function B, and the function C as 1.65, 0.39, and 0.32, respectively.

The main unit lifetime extraction unit 10 extracts, as a main unit lifetime, the lifetime of the functional unit whose unit lifetime scale is the largest from among the unit lifetime scales calculated for the respective functional units. For example, when the unit lifetime scales of the function A, the function B, and the function C are 1.65, 0.39, and 0.32, respectively, the main unit lifetime extraction unit 10 extracts, as a main unit lifetime, 6.35 that is the lifetime of the function A whose unit lifetime scale is the largest.

The output unit 204 in Embodiment 2 outputs information based on the lifetime 9 estimated by the lifetime estimation unit 8 for each of the functional units to, for example, an external device. For example, the output unit 204 may output a unit name that is a name of the functional unit whose lifetime is the worst (the function B in the example above) from among the lifetimes of the respective functional units, its lifetime (−0.11 in the example above), and the software quality data values 3 of the functional unit which cause the lifetime to worsen. The output unit 204 may output, for example, the source code 1, the diagnosed age 5, and the development trend approximate expression 7 of the functional unit whose lifetime is the worst (the function B in the example above), in addition to these. For example, when the input unit 201 receives the numbers of bad lifetimes of the functional units, the output unit 204 may output only the numbers of bad lifetimes in an ascending order.

The output unit 204 in Embodiment 2 outputs information based on the main unit lifetime extracted by the main unit lifetime extraction unit 10 to, for example, an external device. The output unit 204 may output, for example, the main unit lifetime 11 (the lifetime of the function A in the example above). The output unit 204 may output, for example, the source code 1, the software quality data values 3, the development trend approximate expression 7, and the lifetime 9, and the diagnosed age 5 accumulated by the data accumulation unit 203 on the functional unit for which the main unit lifetime 11 has been extracted (the function A in the example above).

The data accumulation unit 203 may accumulate various information, similarly to outputting various information by the output unit 204. The data accumulation unit 203 may accumulate, for example, the source code 1, the software quality data values 3, the diagnosed age 5, the development trend approximate expression 7, the lifetime 9, and the main unit lifetime 11.

### Conclusion of Embodiment 2

Since the lifetime is estimated for each of the functional units in Embodiment 2, it is possible to quantify, for each of the functional units, how much the architecture can be diversely developed and developed for functional additions and can be used in the future. This can facilitate drawing up a guideline for a development project.

Furthermore, information based on the lifetime estimated for each of the functional units is output in Embodiment 2. Since such a configuration allows, for example, notification with which one can recognize a functional unit whose lifetime is relatively bad, drawing up a guideline for a development project can be facilitated.

In Embodiment 2, the main unit lifetime that is a lifetime of one functional unit is extracted based on the influence on the lifetime of the whole source code, and information based on the main unit lifetime is output. Since such a configuration allows, for example, notification with which one can recognize a functional unit whose software quality should not be impaired, drawing up a guideline for a development project can be facilitated.

### Embodiment 3

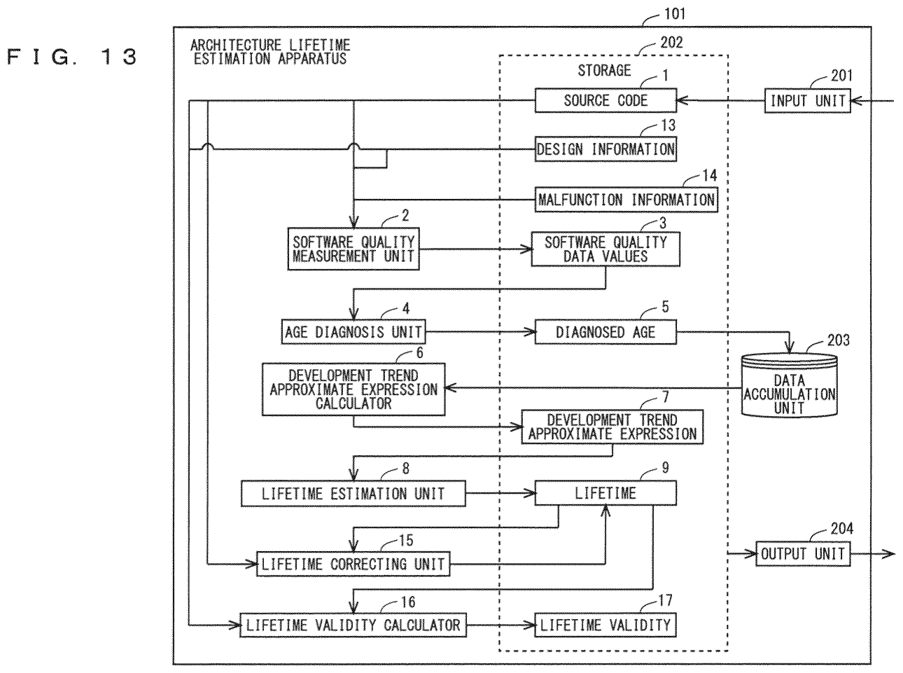

FIG. 13 is a block diagram illustrating a configuration of the architecture lifetime estimation apparatus 101 according to Embodiment 3. Among the constituent elements according to Embodiment 3, the same or similar constituent elements as those described above will have the same or similar reference numerals, and the different constituent elements will be mainly described.

The following will describe a case where the data accumulation unit 203 accumulates the diagnosed age of the revision 1 similarly to Embodiment 1, and the architecture lifetime estimation apparatus 101 estimates an architecture lifetime from the source codes of the revisions 1 and 2.

In Embodiment 3, the lifetime estimated for each of the functional units of software is corrected in consideration of whether a lifetime of a functional unit that is closely related to the functional unit of software is good or bad. Additional input of design information such as an architecture design document or an architecture componentizing design document allows a difference between design and implementation of software in a source code to be reflected on a lifetime. Furthermore, additional input of malfunction information such as an error or a warning in a source code allows the malfunction information to be reflected on a lifetime.

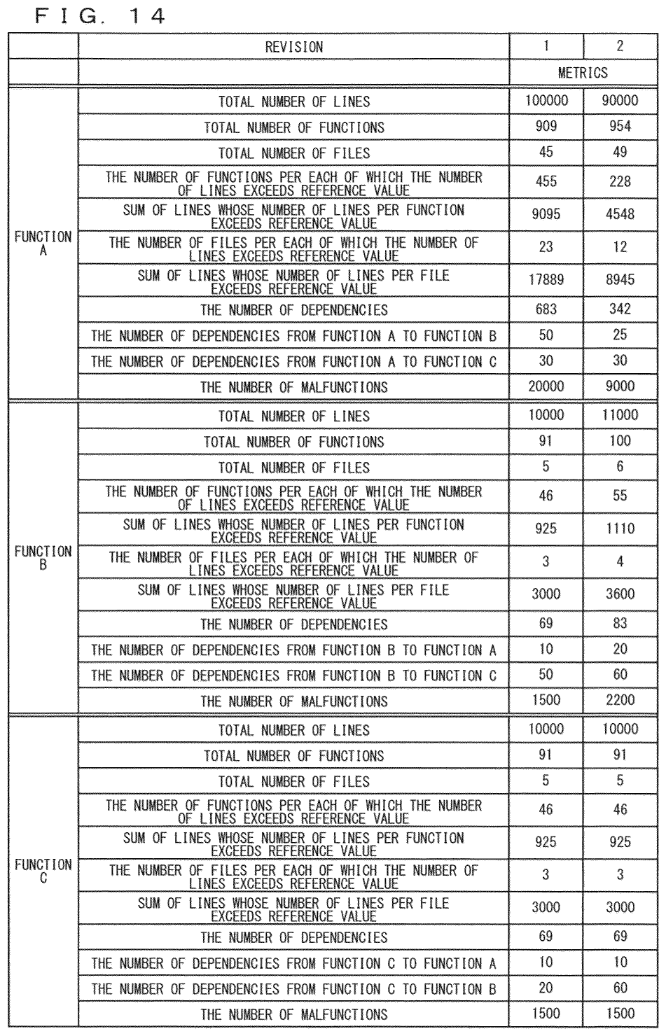

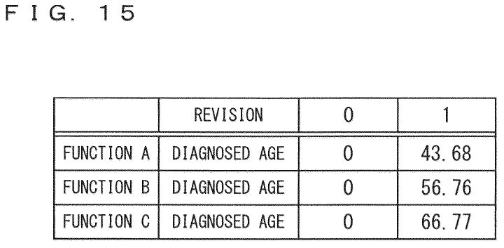

FIG. 14 illustrates example metrics for each of the revisions. As illustrated in FIG. 14, the metrics according to Embodiment 3 further include the number of dependencies, the numbers of dependencies on other functions, and the number of malfunctions. FIG. 15 illustrates example diagnosed ages of the revision 1 which have been calculated by the age diagnosis unit 4 and accumulated by the data accumulation unit 203.

The architecture lifetime estimation apparatus 101 in FIG. 13 has a configuration in which a lifetime correcting unit 15 and a lifetime validity calculator 16 have been added to the configuration in FIG. 1. The storage 202 stores design information 13, malfunction information 14, and lifetime validity 17, in addition to the elements stored in FIG. 1.

The input unit 201 receives and obtains the source code 1, the design information 13, and the malfunction information 14, etc., from, for example, an external device. The storage 202 stores the source code 1, the design information 13, and the malfunction information 14 that have been obtained.

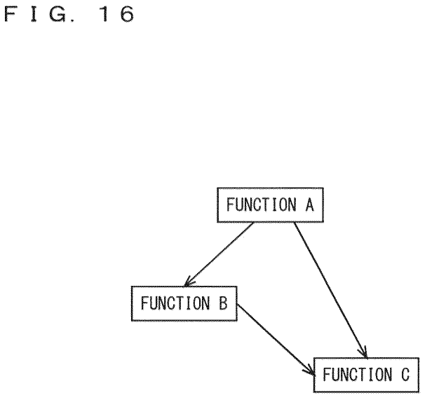

The design information is information indicating an architecture designed in advance for a source code, and includes, for example, dependencies between functional units as illustrated in FIG. 16. The dependency of a certain program on another program means requirement of the other program for building or executing the certain program. The example of FIG. 16 illustrates that the function B depends on the function A and the function C depends on the functions A and B. The design information may include not only the dependencies between functional units but also the dependencies in each of the functional units.

The malfunction information includes, for example, the number of malfunctions that is the number of errors in the source code or the number of warnings about coding standard violation.

The software quality measurement unit 2 extracts, from the source code 1, for example, the total number of lines, the total number of functions, the total number of files, the number of dependencies, the numbers of dependencies on other functions, and the number of malfunctions as metrics for each of the functional units as illustrated in FIG. 14. The software quality measurement unit 2 measures the software quality data values 3 for each of the functional units, based on the metrics extracted for the functional unit.

For example, the software quality measurement unit 2 calculates a software quality data value using Equations (1) to (4), and (7) and (8).

$$\begin{matrix}[ Math 7 ] & \\ A software quality data value ( the number of violation dependencies ) = \frac{the number of violation dependencies}{( the number of dependencies ) - ( the number of violation dependencies )} & ( 7 )\end{matrix}$$

$$\begin{matrix}[ Math 8 ] & \\ A software quality data value ( the number of malfunctions ) = \frac{the number of malfunctions}{( the total number of lines ) - ( the number of malfunctions )} & ( 8 )\end{matrix}$$

The number of violation dependencies in Equation (7) is the number of dependencies that are not described in a design document on design information, from among dependencies from a certain functional unit to another functional unit. When the design document on design information includes the dependencies in each of the functional units, the number of violation dependencies in the functional unit may be taken into consideration in calculating Equation (7). Equations (7) and (8) are defined as 0 when the software quality data values indicate the highest quality, and defined to diverge to infinity when the software quality data values indicate the lowest quality, similarly to Equations (1) to (4).

As such, the software quality measurement unit 2 according to Embodiment 3 calculates a value to be used as a software quality data value, based on a difference between the architecture of the source code 1 itself and the architecture indicated by the design information 13. As a result of this, the difference between the architecture of the source code 1 itself and the architecture indicated by the design information 13 is reflected on the lifetime 9.

Furthermore, the software quality measurement unit 2 calculates a value to be used as a software quality data value, based on the malfunction information 14. As a result of this, the malfunction information 14 is reflected on the lifetime 9.

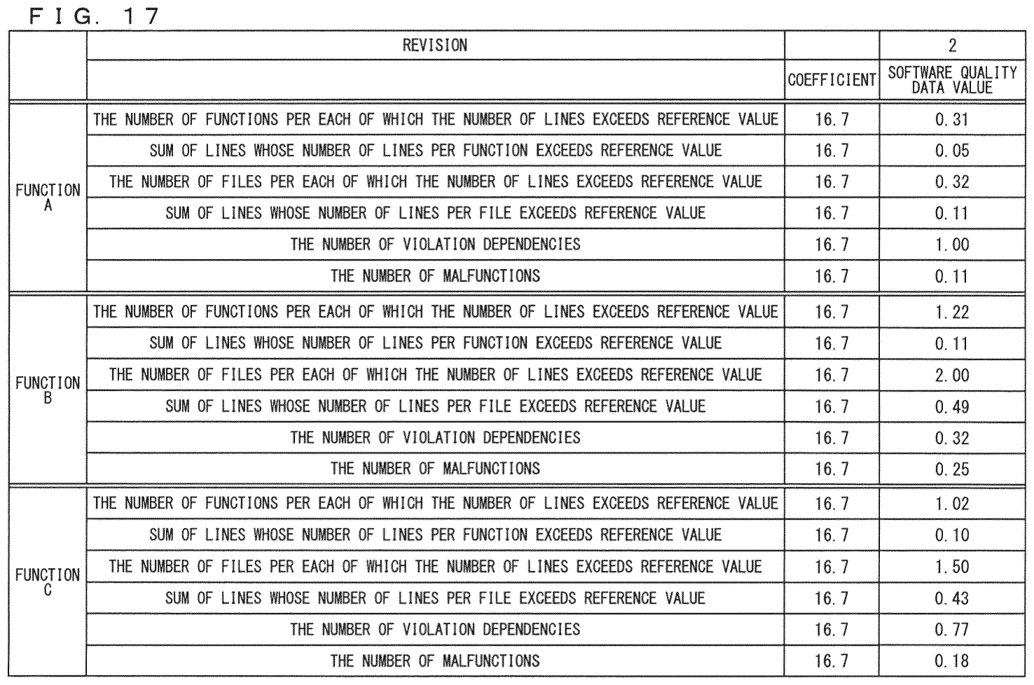

FIG. 17 illustrates example software quality data values, specifically, software quality data values of the revision 2. In the example of FIG. 17, assuming that six software quality data values equivalently influence the software quality, each of the coefficients of the six software quality data values is defined as 16.7 obtained by dividing the total of 100 into equal parts for convenience.

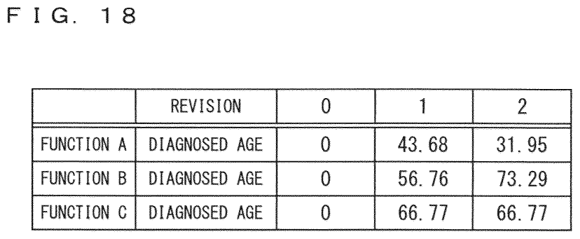

The age diagnosis unit 4 calculates the diagnosed age 5 for each of the functional units, based on the software quality data values 3 measured for the functional unit. The age diagnosis unit 4 stores the diagnosed age 5 calculated for each of the functional units in the data accumulation unit 203. The data accumulation unit 203 accumulates the diagnosed age 5 for each of the revisions of the source code and for each of the functional units as illustrated in FIG. 18.

The development trend approximate expression calculator 6 calculates the development trend approximate expression 7 for each of the functional units, based on the diagnosed age 5 accumulated by the data accumulation unit 203 for each of the revisions and for each of the functional units. For example, the development trend approximate expression calculator 6 performs a linear approximation such as the least square method on the diagnosed age of the function A to calculate y=15.97x+9.24 as a development trend approximate expression of the function A. Similarly, the development trend approximate expression calculator 6 calculates y=36.64x+6.71 as the development trend approximate expression 7 of the function B, and calculates y=33.39x+11.13 as the development trend approximate expression of the function C.

The lifetime estimation unit 8 estimates the lifetime 9 of the source code for each of the functional units, based on the development trend approximate expression 7 calculated for the functional unit. In the example above, the lifetime estimation unit 8 calculates 3.68 as the lifetime of the function A, calculates 0.55 as the lifetime of the function B, and calculates 0.66 as the lifetime of the function C.

The lifetime correcting unit 15 corrects the lifetime 9 for each of the functional units, based on the lifetimes 9 estimated by the lifetime estimation unit 8 for the functional unit and dependencies between the functional units. For example, the lifetime correcting unit 15 changes whether a lifetime of a certain functional unit (hereinafter referred to as a first functional unit) is good or bad, according to whether the lifetime of another functional unit (hereinafter referred to as a second functional unit) that is closely related to the certain functional unit is good or bad.

As one example, when a lifetime of the second functional unit on which the first functional unit depends the most is lower than a lifetime of the first functional unit, the lifetime correcting unit 15 decreases the lifetime of the first functional unit by 10%. When the lifetime of the second functional unit on which the first functional unit depends the most is higher than the lifetime of the first functional unit, the lifetime correcting unit 15 increases the lifetime of the first functional unit by 10%. For example, the number of dependencies in the metrics extracted from the source code 1 in FIG. 14 is used as a degree of the dependency.

In the example of FIG. 14, the number of dependencies from the function A to the function B in the revision 2 is 25, and the number of dependencies from the function A to the function C in the revision 2 is 30. Thus, the function on which the function A depends the most is the function C out of the functions B and C. Since the lifetime (0.66) of the function C is lower than the lifetime (3.68) of the function A in the example above, the lifetime correcting unit 15 corrects the lifetime of the function A to 3.35 by decreasing 3.68 by 10%.

Similarly, the lifetime (0.66) of the function C on which the function B depends the most is higher than the lifetime (0.55) of the function B. Thus, the lifetime correcting unit 15 corrects the lifetime of the function B to 0.61 by increasing 0.55 by 10%. Since the lifetime (0.55) of the function B on which the function C depends the most is lower than the lifetime (0.66) of the function C, the lifetime correcting unit 15 corrects the lifetime of the function C to 0.60 by decreasing 0.66 by 10%.

In the example above, the lifetime correcting unit 15 corrects the lifetime of the first functional unit, based on the lifetime of the second functional unit whose number of dependencies on the first functional unit is the largest, which is not limited to this. For example, when the input unit 201 receives the number of functional units to be used for correction, the lifetime correcting unit 15 may identify the second functional units as many as the received number in order from the second functional unit whose number of dependencies on the first functional unit is larger, and correct the lifetime of the first functional unit, based on the lifetimes of the second functional units of the identified number.

The lifetime validity calculator 16 calculates the lifetime validity 17 that is validity of a lifetime for each of the functional units, based on the difference between the architecture of the source code 1 itself and the architecture indicated by the design information 13. For example, the lifetime validity calculator 16 may calculate the lifetime validity of a certain functional unit as 100% when there is no difference between the dependency on the source code 1 itself and the dependency indicated by the design information in the certain functional unit. When a difference between the dependency on the source code 1 itself and the dependency indicated by the design information in a certain functional unit is larger than or equal to a threshold, the lifetime validity calculator 16 may calculate the lifetime validity of the certain functional unit as 0%.

The output unit 204 outputs the information based on the lifetime 9 estimated by the lifetime estimation unit 8 for each of the functional units, and information based on the lifetime validity 17 calculated by the lifetime validity calculator 16 to, for example, an external device. The output unit 204 may output, for example, the source code 1, the software quality data values 3, the development trend approximate expression 7, the lifetimes 9 before and after correction by the lifetime correcting unit 15, the design information 13, the malfunction information 14, and the lifetime validity 17, and the diagnosed age 5 accumulated by the data accumulation unit 203.

The data accumulation unit 203 may accumulate various information, similarly to outputting various information by the output unit 204. The data accumulation unit 203 may accumulate, for example, the source code 1, the software quality data values 3, the diagnosed age 5, the development trend approximate expression 7, the lifetimes 9 before and after correction by the lifetime correcting unit 15, the design information 13, the malfunction information 14, and the lifetime validity 17.

### Conclusion of Embodiment 3

Since the lifetime is corrected for each of the functional units based on the lifetime estimated for the functional unit and the dependencies between the functional units in Embodiment 3, the accuracy of the lifetime can be increased.

Since the difference between the architecture of the source code itself and the architecture indicated by the design information is reflected on the lifetime in Embodiment 3, the accuracy of the lifetime can be increased.

In Embodiment 3, the lifetime validity that is validity of a lifetime for each of the functional units is calculated, based on the difference between the architecture of the source code itself and the architecture indicated by the design information, and information based on the lifetime validity is output. Since such a configuration allows, for example, notification with which one can recognize the validity of the estimated lifetime, drawing up a guideline for a development project can be facilitated.

Since the malfunction information is reflected on the lifetime in Embodiment 3, the accuracy of the lifetime can be increased.

### Embodiment 4

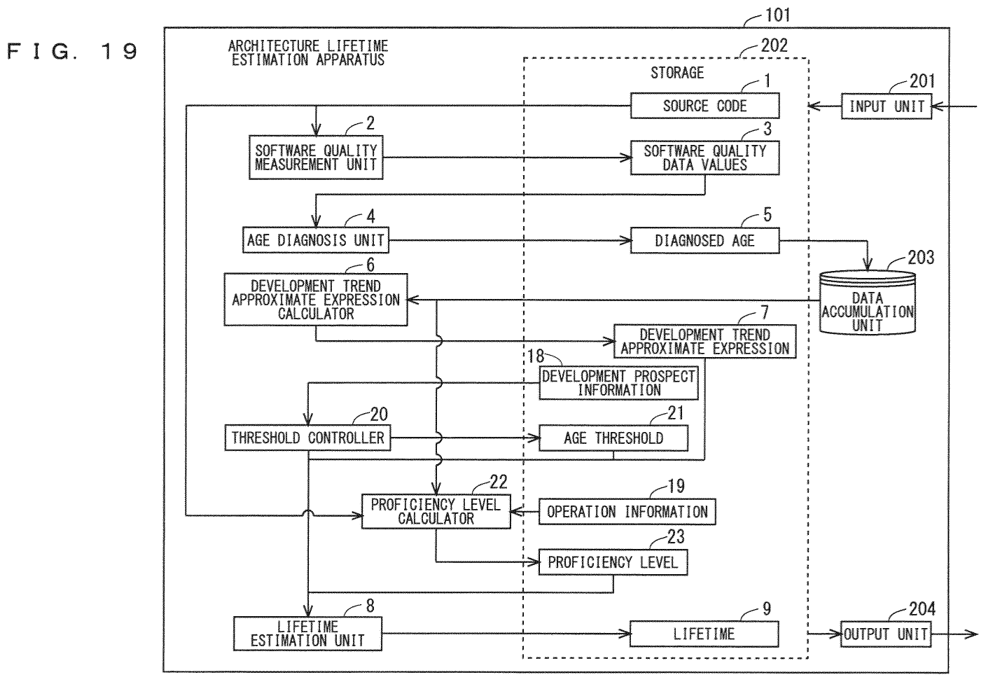

FIG. 19 is a block diagram illustrating a configuration of the architecture lifetime estimation apparatus 101 according to Embodiment 4. Among the constituent elements according to Embodiment 4, the same or similar constituent elements as those described above will have the same or similar reference numerals, and the different constituent elements will be mainly described.

The following will describe a case where the data accumulation unit 203 accumulates the diagnosed age of the revision 1 similarly to Embodiment 1 and the architecture lifetime estimation apparatus 101 estimates an architecture lifetime from the source codes of the revisions 1 and 2.

In Embodiment 4, an age threshold that is related to an intercept of a development trend approximate expression is controlled for each of functional units of software, based on development prospect information for the functional unit. The development prospect information includes additional development prospects or maintenance prospects. Furthermore, a proficiency level of an operator who has developed software is reflected on a slope of the development trend approximate expression, based on operation information including the operator and the operating time.

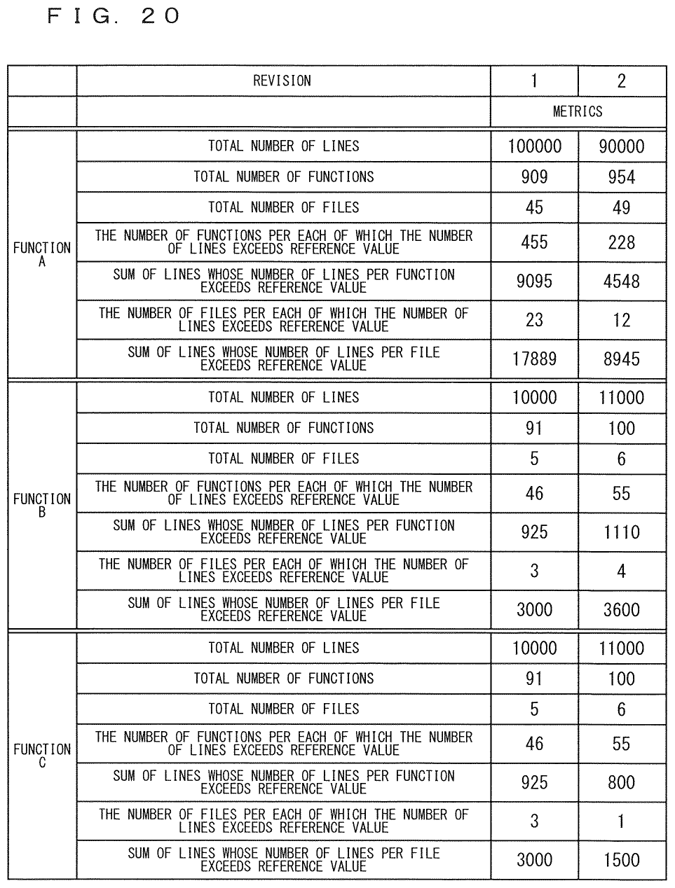

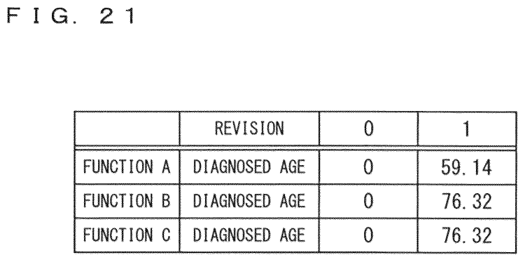

FIG. 20 illustrates example metrics for each of the revisions. FIG. 21 illustrates example diagnosed ages of the revision 1 which have been calculated by the age diagnosis unit 4 and accumulated by the data accumulation unit 203.

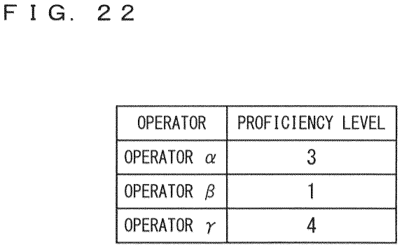

FIG. 22 illustrates proficiency levels of operators calculated when the diagnosed ages of the revision 1 have been calculated and accumulated by the data accumulation unit 203. The following will describe an example where operators α, β, and γ develop source codes. Calculation of the proficiency level will be described together with calculation of the diagnosed ages of the revision 2 to be described later.

The architecture lifetime estimation apparatus 101 in FIG. 19 has a configuration in which a threshold controller 20 and a proficiency level calculator 22 have been added to the configuration in FIG. 1. The storage 202 stores development prospect information 18, operation information 19, an age threshold 21, and a proficiency level 23 in addition to the elements stored in FIG. 1.

The input unit 201 receives and obtains the source code 1, the development prospect information 18, and the operation information 19 from, for example, an external device. The storage 202 stores the source code 1, the development prospect information 18, and the operation information 19 that have been obtained.

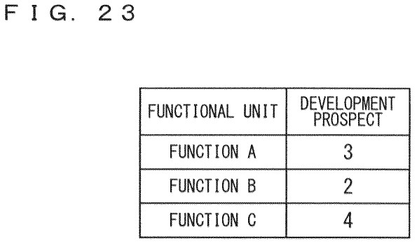

The development prospect information includes, for example, a value indicating a development prospect for each of the functional units as illustrated in FIG. 23. The value in the example of FIG. 23 is any one of 1 to 5. “1” is associated with a rare prospect of development, and “5” is associated with a very frequent prospect of development.

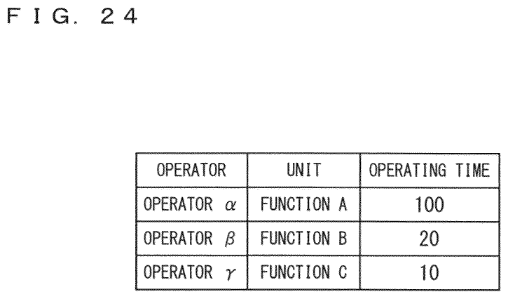

The operation information is information on operators, and includes, for example, the operators, a functional unit developed by each of the operators, and an operating time taken for the development as illustrated in FIG. 24.

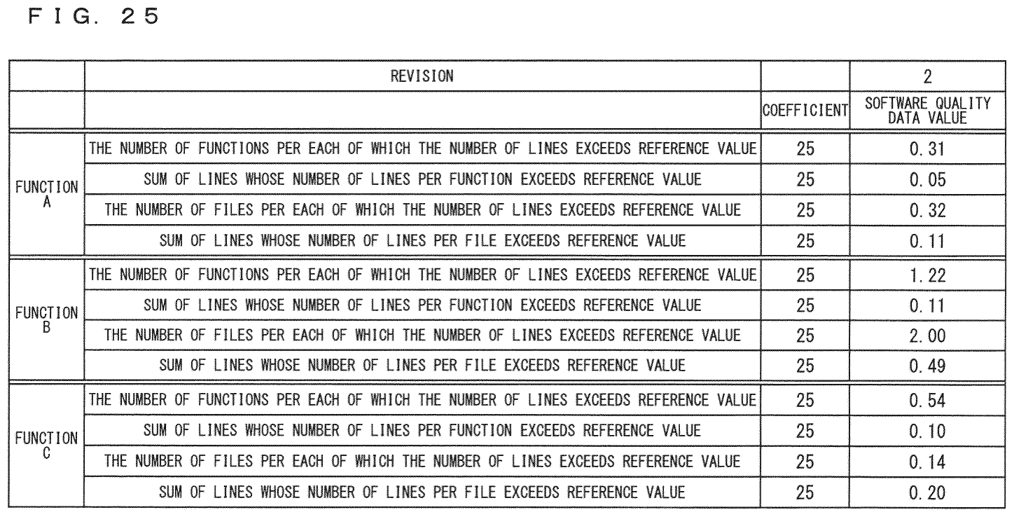

The software quality measurement unit 2 extracts, from the source code 1, for example, the metrics as illustrated in FIG. 20. The data accumulation unit 203 may accumulate the extracted metrics. The software quality measurement unit 2 measures the software quality data values 3 for each of the functional units, based on the metrics extracted for the functional unit. FIG. 25 illustrates example software quality data values, specifically, software quality data values of the revision 2.

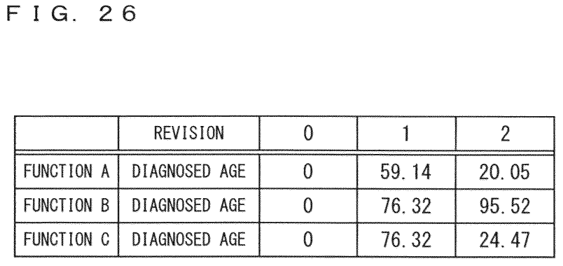

The age diagnosis unit 4 calculates the diagnosed age 5 for each of the functional units, based on the software quality data values 3 measured for the functional unit. The age diagnosis unit 4 stores the diagnosed age 5 calculated for each of the functional units in the data accumulation unit 203. The data accumulation unit 203 accumulates the diagnosed age 5 for each of the revisions of the source code and for each of the functional units as illustrated in FIG. 26.

The development trend approximate expression calculator 6 calculates the development trend approximate expression 7 for each of the functional units, based on the diagnosed age 5 accumulated by the data accumulation unit 203 for each of the revisions and for each of the functional units. For example, the development trend approximate expression calculator 6 performs a linear approximation such as the least square method on the diagnosed age of the function A to calculate y=10.02x+16.37 as a development trend approximate expression of the function A. Similarly, the development trend approximate expression calculator 6 calculates y=47.76x+9.52 as the development trend approximate expression 7 of the function B, and calculates y=38.16x+12.72 as the development trend approximate expression of the function C.

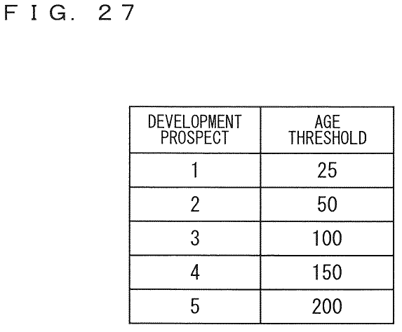

The threshold controller 20 controls the age threshold 21 for each of the functional units, based on the development prospect information 18 for the functional unit. For example, the threshold controller 20 defines, for each of the functional units, the age threshold 21 corresponding to a development prospect indicated by the development prospect information 18 as illustrated in FIG. 23, using a correspondence table between the development prospects and the age thresholds as illustrated in FIG. 27. Although the age threshold is a given value of 100 in Embodiments 1 to 3, for example, the age threshold of the function B is defined as 50 in Embodiment 4. This is because the development prospect of the function B is 2 in FIG. 23.

The proficiency level calculator 22 calculates the proficiency levels of the operators, based on the source code 1, the operation information 19, and the diagnosed age 5 accumulated by the data accumulation unit 203 for each of the revisions.

The proficiency level calculator 22 obtains, for example, the total number of lines of the current revision 2 for each of the functional units from the source code 1, and the total number of lines of the previous revision 1 for each of the functional units from the data accumulation unit 203. The proficiency level calculator 22 obtains the diagnosed ages 5 of the current revision 2 and the previous revision 1 from the data accumulation unit 203, and obtains the operation information 19 from the storage 202. Then, the proficiency level calculator 22 calculates a proficiency value using Equation (9).

$$\begin{matrix}[ Math 9 ] & \\ A proficiency value = ( a diagnosed age of the current revision - a diagnosed age of the previous revision ) \times \frac{\vert ( the total number of lines of the current revision ) - ( the total number of lines of the previous revision ) \vert}{an operating time} & ( 9 )\end{matrix}$$

Thus, the proficiency level calculator 22 calculates, for example, the proficiency values of the operators of the function A, the function B, and the function C to be −3909, 960, and −5184, respectively. Since the operators of the function A, the function B, and the function C are the operator α, the operator β, and the operator γ in the example of FIG. 24, the proficiency level calculator 22 calculates the proficiency levels of the operator α, the operator β, and the operator γ to be −3909, 960, and −5184, respectively. When an operator performs development operations for a plurality of functional units, a statistic of proficiency values calculated for the plurality of functional units, such as an average and a weighted average may be used as a proficiency value of the operator.

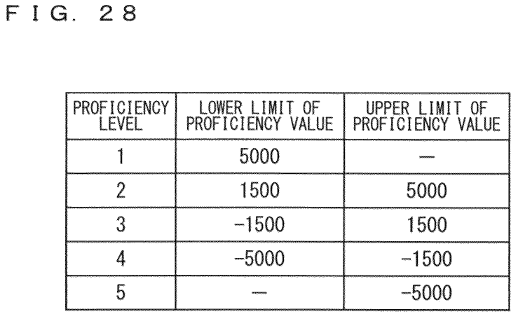

Next, the proficiency level calculator 22 identifies, for example, a proficiency level of only the current operation corresponding to the calculated proficiency value, using a correspondence table between proficiency values and proficiency levels as illustrated in FIG. 28. When proficiency values of the operator α, the operator β, and the operator γ are −3909, 960, and −5184, the proficiency level calculator 22 identifies the proficiency levels of the operator α, the operator β, and the operator γ for only the current operations to be 4, 3, and 5, respectively.

Then, the proficiency level calculator 22 calculates, as a new proficiency level, a value obtained by rounding off the fractional portion of an average of the proficiency level of the operator for only the current operation and the proficiency level of the operator accumulated by the data accumulation unit 203. For example, when the operator α, the operator β, and the operator γ have the proficiency levels of 4, 3, and 5 for only the current operations and the proficiency levels of 3, 1, and 4 which are accumulated in the data accumulation unit 203 as illustrated in FIG. 22, the proficiency level calculator 22 calculates the new proficiency levels of the operator α, the operator β, and the operator γ to be 4, 2, and 5, respectively.

The new proficiency levels are not limited to those described above. For example, the proficiency levels of the operators for only the current operations may be used as new proficiency levels as they are. The new proficiency levels are stored in the storage 202 and accumulated by the data accumulation unit 203.

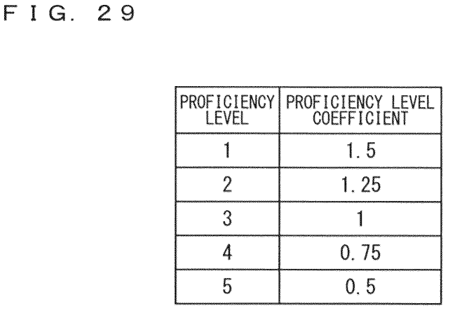

The lifetime estimation unit 8 estimates the lifetime 9 for each of the functional units, based on the development trend approximate expression 7, the age threshold 21, and the new proficiency level 23. The lifetime estimation unit 8, for example, identifies a proficiency level coefficient corresponding to a new proficiency value, using a correspondence table between the proficiency levels and proficiency level coefficients as illustrated in FIG. 29. Then, the lifetime estimation unit 8 calculates a lifetime for each of the functional units, by substituting the development trend approximate expression 7, the age threshold 21, and the proficiency level coefficient into Equation (10).

$$\begin{matrix}[ Math 10 ] & \\ A lifetime = \frac{an age threshold - ( an intercept of a development trend approximate expression )}{( a slope of the development trend approximate expression ) \times a proficiency level coefficient} - ( a revision number ) & ( 10 )\end{matrix}$$

In the example above, the lifetime estimation unit 8 calculates the lifetimes of the function A, the function B, and the function C to be 9.13, −1.32, and 19.02, respectively. In FIG. 27, the larger the development prospect is, the larger the age threshold in Equation (10) becomes, and therefore the lifetime calculated by the lifetime estimation unit 8 is increased. Moreover, in FIG. 29, the higher the proficiency level is, the smaller the proficiency level coefficient in Equation (10) becomes, and therefore the lifetime calculated by the lifetime estimation unit 8 is increased.

The output unit 204 outputs information based on the lifetime 9 estimated by the lifetime estimation unit 8 for each of the functional units to, for example, an external device. The output unit 204 may output, for example, the source code 1, the software quality data values 3, the development trend approximate expression 7, the lifetime 9, the development prospect information 18, the operation information 19, the age threshold 21, and the proficiency level 23, and the diagnosed age 5 accumulated by the data accumulation unit 203.

The data accumulation unit 203 may accumulate various information, similarly to outputting various information by the output unit 204. The data accumulation unit 203 may store, for example, the source code 1, the software quality data values 3, the diagnosed age 5, the development trend approximate expression 7, the lifetime 9, the development prospect information 18, the operation information 19, the age threshold 21, and the proficiency level 23.

### Conclusion of Embodiment 4

In Embodiment 4, the age threshold is controlled for each of the functional units based on the development prospect information for the functional unit, and the lifetime is estimated for the functional unit based on the development trend approximate expression and the age threshold. Thus, the accuracy of the lifetime can be increased.

Since the lifetime is estimated based on the development trend approximate expression and the proficiency level of the operator in Embodiment 4, the accuracy of the lifetime can be increased.

### Embodiment 5

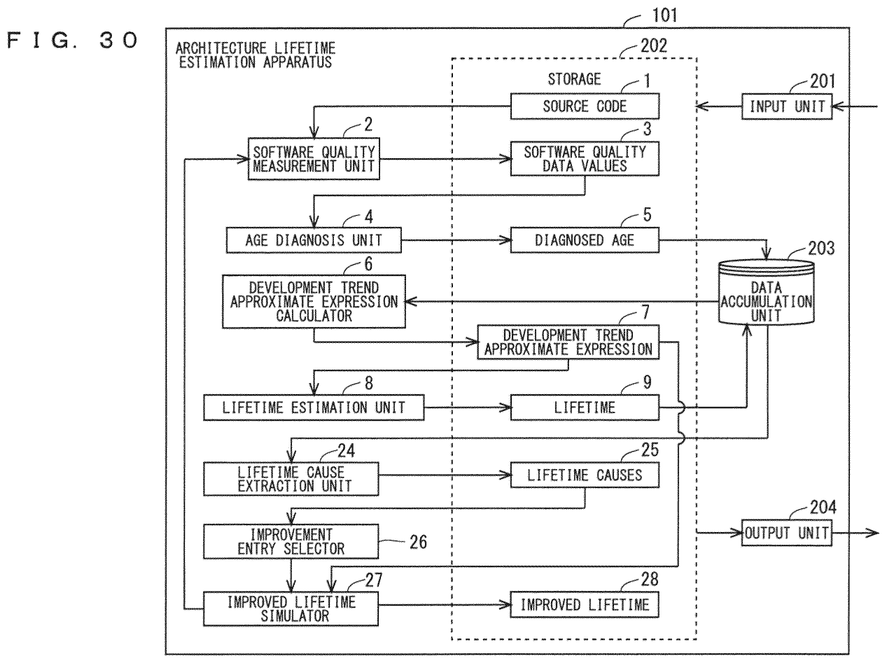

FIG. 30 is a block diagram illustrating a configuration of the architecture lifetime estimation apparatus 101 according to Embodiment 5. Among the constituent elements according to Embodiment 5, the same or similar constituent elements as those described above will have the same or similar reference numerals, and the different constituent elements will be mainly described.

The following will describe a case where the data accumulation unit 203 accumulates the diagnosed age of the revision 1 similarly to Embodiment 1 and the architecture lifetime estimation apparatus 101 estimates an architecture lifetime from the source codes of the revisions 1 and 2.

The architecture lifetime estimation apparatus 101 in FIG. 30 has a configuration in which a lifetime cause extraction unit 24, an improvement entry selector 26, and an improved lifetime simulator 27 have been added to the configuration in FIG. 1. The storage 202 stores lifetime causes 25 and an improved lifetime 28 in addition to the elements stored in FIG. 1.

The data accumulation unit 203 accumulates the metrics and the software quality data values 3 that have been extracted by the software quality measurement unit 2 from the source code 1 for each of the revisions of the source code. The lifetime cause extraction unit 24 extracts the metrics and the software quality data values 3 to be causes on whether the lifetime 9 is good or bad, as the lifetime causes 25. The lifetime cause extraction unit 24 in Embodiment 5 extracts, as the lifetime causes 25 that negatively influence the lifetime 9, the software quality data values 3 larger than or equal to a predetermined threshold, and the metrics from which the software quality data values 3 are calculated.

The improvement entry selector 26 selects a part or a whole of the lifetime causes 25 that negatively influence the lifetime 9. The improvement entry selector 26 in Embodiment 5 selects a part or the whole of the lifetime causes 25 extracted by the lifetime cause extraction unit 24.

The improved lifetime simulator 27 estimates the improved lifetime 28, based on the development trend approximate expression 7 calculated from the diagnosed age 5 when the lifetime causes 25 selected by the improvement entry selector 26 are improved. In other words, the improved lifetime simulator 27 simulates how much the lifetime 9 will be improved when the lifetime causes 25 selected by the improvement entry selector 26 are improved.

Embodiment 5 describes that the improvement entry selector 26 selects one of the lifetime causes 25 which the most negatively influences the lifetime 9, as the lifetime cause 25 to be improved, which is not limited to this. For example, a plurality of or the whole of the lifetime causes 25 which the most negatively influence the lifetime 9 may be selected, or the lifetime causes 25 which the most negatively influence the lifetime 9 may be automatically selected by a device or by the user through the input unit 201.

An improvement degree may be similarly selected. Although the following will describe a case where the improved lifetime simulator 27 simulates, as the improved lifetime 28, the lifetime 9 when one of the lifetime causes 25 has been improved by 100% and resolved, the improved lifetime simulator 27 can simulate, as the improved lifetime 28, the lifetime 9 a part of which has been improved. After simulating an improvement degree of the lifetime 9 once, the improved lifetime simulator 27 can take over the result and simulate the improvement degree together with an improvement degree of the other lifetime cause 25, or separately simulate the improvement degree of the other lifetime cause 25 without taking over the result. Although the following will describe a case where processing is performed on the lifetime of the whole software, that is, the lifetime 9 of the whole source code, the source code may be partitioned per predefined unit in Embodiment 2 and the following processing may be performed on the lifetime 9 estimated for each of the predefined units.

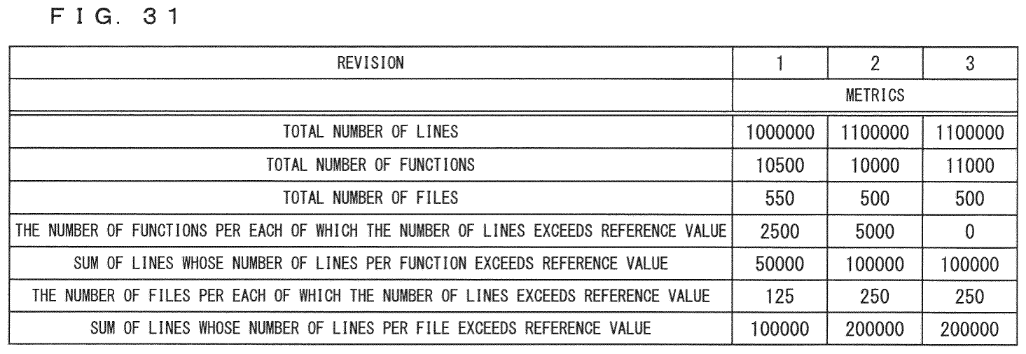

FIG. 31 illustrates example metrics for each of the revisions. The metrics of the revisions 1 and 2 illustrated in FIG. 31 are identical to those according to Embodiment 1 (see FIG. 2). Thus, the diagnosed age of the revision 1 (19.26), the diagnosed age of the revision 2 (58.06), the development trend approximate expression for these (v=29.03x−3.26), and the lifetime of the revision 2 (1.56), which are calculated later in Embodiment 5, are identical to those according to Embodiment 1. The revision 3 will be described later.

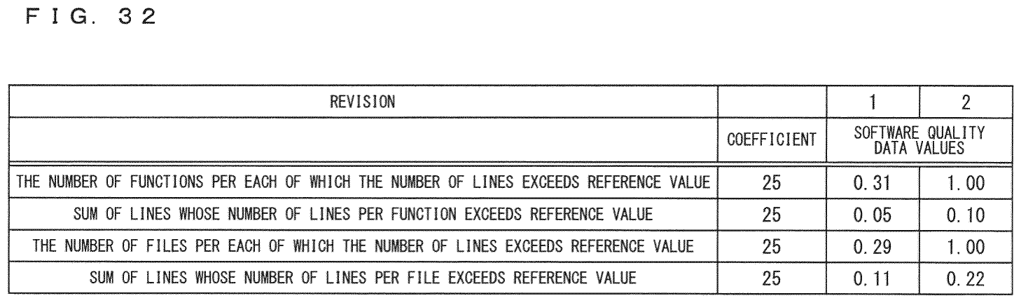

FIG. 32 indicates software quality data values to be causes of the lifetime of the revision 2. The larger the software quality data values are, the higher the diagnosed age in Equation (5) becomes. This negatively influences the lifetime 9. The lifetime cause extraction unit 24 in Embodiment 5 extracts, as one lifetime cause, one software quality data value that is the highest and the most negatively influences the lifetime, and metrics that are sources of the calculation of the one software quality data value. The following will describe a specific example where the lifetime cause extraction unit 24 determines that the software quality data value and the metrics on “the number of functions per each of which the number of lines exceeds a reference value” the most negatively influence the lifetime, and extracts the software quality data value and the metrics as one lifetime cause.

The lifetime cause extraction unit 24 can extract plural sets of the software quality data value and the metrics which negatively influence the lifetime. The lifetime cause extraction unit 24 can also extract one set or plural sets of the software quality data value and the metrics which positively influence the lifetime, and present the set or the plural sets as an implementation model case.

The improvement entry selector 26 selects a lifetime cause to be improved from among the lifetime causes extracted by the lifetime cause extraction unit 24. Since the lifetime cause extraction unit 24 extracts one lifetime cause in the example above, the improvement entry selector 26 selects the one lifetime cause as it is. When the lifetime cause extraction unit 24 extracts a plurality of lifetime causes, the improvement entry selector 26 or the user may select at least one lifetime cause from among the plurality of lifetime causes. For example, the improvement entry selector 26 may select at least one lifetime cause from among the plurality of lifetime causes extracted by the lifetime cause extraction unit 24, based on the software quality data value.

The improved lifetime simulator 27 improves the lifetime cause selected by the improvement entry selector 26. For example, the improved lifetime simulator 27 adds, to the revision 3, simulation metrics with which the software quality data value on “the number of functions per each of which the number of lines exceeds a reference value” is equal to 0, that is, the simulation metrics with which the lifetime cause will be improved by 100% as illustrated in FIG. 31. Such simulation metrics can be determined by, for example, solving an optimal problem using values of the metrics as variables so that the value in Equation (1) is equal to 0.

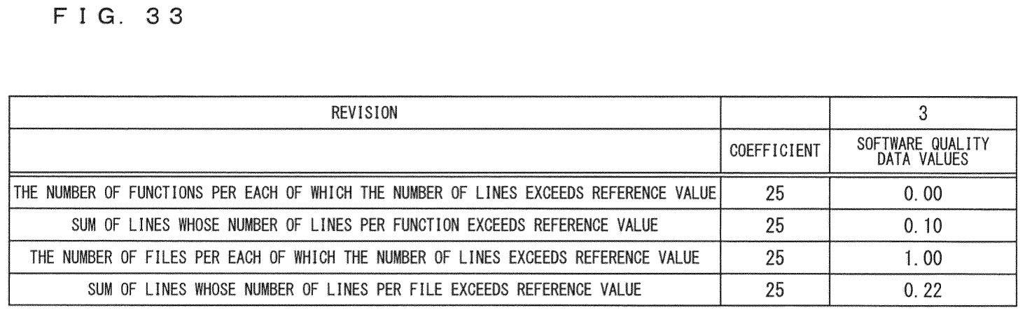

The software quality measurement unit 2 measures software quality data values each indicating the quality of the source code, based on the metrics in FIG. 31. FIG. 33 illustrates example software quality data values, specifically, software quality data values of the revision 3. With the simulation metrics being reflected, the software quality data value on “the number of functions per each of which the number of lines exceeds a reference value” is equal to 0. Although the improved lifetime simulator 27 herein generates the simulation metrics so that the software quality data value on “the number of functions per each of which the number of lines exceeds a reference value” is equal to 0, an improved value and a degree of improvement are not limited to these. The improved value and the degree of improvement may be designated by a device, or by the user through the input unit 201.

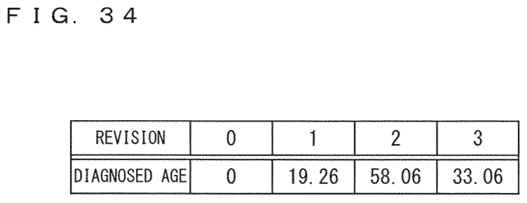

The age diagnosis unit 4 calculates the diagnosed age, based on the software quality data values measured by the software quality measurement unit 2, similarly to Embodiment 1. With FIG. 33, the age diagnosis unit 4 calculates 33.06 as the diagnosed age of the revision 3, and stores the diagnosed age in the data accumulation unit 203. In this manner, the data accumulation unit 203 accumulates the diagnosed age for each of the revisions as illustrated in FIG. 34.

The development trend approximate expression calculator 6 calculates a development trend approximate expression, based on the diagnosed age accumulated by the data accumulation unit 203 for each of the revisions, similarly to Embodiment 1. For example, the development trend approximate expression calculator 6 performs a linear approximation such as the least square method to calculate y=14.20x+6.63 as a development trend approximate expression.

The improved lifetime simulator 27 estimates an improved lifetime based on the development trend approximate expression, similarly to the estimation of the lifetime by the lifetime estimation unit 8. In the example above, the lifetime estimation unit 8 calculates 6.58 as a revision satisfying y=100 in 14.20x+6.63, and calculates 3.58 as an improved lifetime by subtracting 3 of the current revision from 6.58 of the calculated revision.

The output unit 204 in FIG. 30 outputs the improved lifetime 28. The output unit 204 may output, for example, the source code 1, the software quality data values 3, the development trend approximate expression 7, the lifetime causes 25, the improved simulation metrics, the improved software quality data values 3, the improved diagnosed age 5, and the improved development trend approximate expression 7, and the diagnosed ages accumulated by the data accumulation unit 203.

The data accumulation unit 203 may accumulate various information, similarly to outputting various information by the output unit 204. For example, the data accumulation unit 203 may accumulate the source code 1, the software quality data values 3, the diagnosed age 5, the development trend approximate expression 7, the lifetime causes 25, the improved simulation metrics, the improved software quality data values 3, the improved diagnosed age 5, and the improved development trend approximate expression 7.

### Conclusion of Embodiment 5

Presentation of the lifetime causes 25 for the current software in Embodiment 5 can specify portions to be corrected when the long-term diversion development is continued in the future.

Since the improved lifetime 28 when a part or the whole of the lifetime causes 25 that negatively influence the lifetime 9 have been improved can be presented in Embodiment 5, drawing up a guideline on whether the lifetime causes 25 should be improved compared to the lifetime 9 can be facilitated. Repetition of partly selecting the lifetime causes 25 to be improved and estimating the improved lifetime 28 can assign priorities to the lifetime causes 25 to be improved. This can facilitate drawing up a plan for allowing stepwise implementation of improvement activities, in parallel with new development activities on software.

### Other Modifications

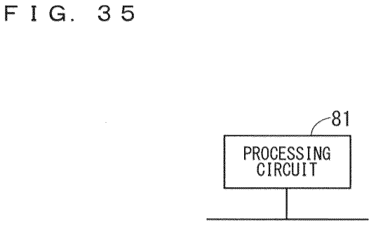

The obtaining unit including the input unit 201 in FIG. 1, and the software quality measurement unit 2, the age diagnosis unit 4 (a diagnosed age calculator), the development trend approximate expression calculator 6, and the lifetime estimation unit 8 will be hereinafter referred to as an “obtaining unit and others”. A processing circuit 81 in FIG. 35 implements the obtaining unit and others. In other words, the processing circuit 81 includes: an obtaining unit to obtain a source code; a software quality measurement unit to measure software quality data values based on the source code; a diagnosed age calculator to calculate a diagnosed age of the source code based on the software quality data values; a development trend approximate expression calculator to calculate a development trend approximate expression based on the diagnosed age accumulated by the data accumulation unit for each of the revisions; and a lifetime estimation unit to estimate a lifetime based on the development trend approximate expression. This processing circuit 81 may be dedicated hardware, or a processor that executes a program stored in a memory. Examples of the processor include a central processing unit, a processing unit, an arithmetic unit, a microprocessor, a microcomputer, and a digital signal processor (DSP).

When the processing circuit 81 is dedicated hardware, the processing circuit 81 is, for example, a single circuit, a composite circuit, a programmed processor, a parallel-programmed processor, an application-specific integrated circuit (ASIC), a field-programmable gate array (FPGA), or any combination of these. The functions of the units such as the obtaining unit and others may be implemented by a circuit obtained by distributing a processing circuit, or the functions of the units may be collectively implemented by a single processing circuit.

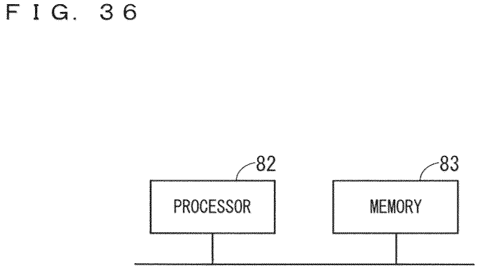

When the processing circuit 81 is a processor, the functions of the obtaining unit and others are implemented by any combinations with software, etc. The software, etc., is, for example, software, firmware, or the software and the firmware. For example, the software is described as a program, and stored in a memory. As illustrated in FIG. 36, a processor 82 to be applied as the processing circuit 81 implements the functions of each of the units by reading and executing a program stored in a memory 83. In other words, the architecture lifetime estimation apparatus 101 includes the memory 83 for storing a program which, when executed by the processing circuit 81, consequently executes the steps of: obtaining a source code; measuring software quality data values based on the source code; calculating a diagnosed age of the source code based on the software quality data values; accumulating the diagnosed age for each of revisions of the source code in a data accumulation unit; calculating a development trend approximate expression based on the diagnosed age accumulated in the data accumulation unit for each of the revisions; and estimating a lifetime based on the development trend approximate expression. Put it differently, this program causes a computer to execute procedures or methods to be performed by the obtaining unit and others. Here, examples of the memory 83 may include non-volatile or volatile semiconductor memories such as a random-access memory (RAM), a read-only memory (ROM), a flash memory, an erasable programmable read-only memory (EPROM), and an electrically erasable programmable read-only memory (EEPROM), a hard disk drive (HDD), a magnetic disc, a flexible disk, an optical disk, a compact disk, a mini disk, a digital versatile disc (DVD), a drive device thereof, and further any storage medium to be used in the future.

The configuration for implementing the functions of the obtaining unit and others using one of the hardware and the software, etc., is described above. However, the configuration is not limited to this. A part of the obtaining unit and others may be implemented by dedicated hardware, and another part thereof may be implemented by software, etc. For example, the processing circuit 81, an interface, and a receiver which function as the dedicated hardware can implement the functions of the obtaining unit, and the processing circuit 81 functioning as the processor 82 can implement the functions of the others through reading and executing the program stored in the memory 83.

As described above, the processing circuit 81 can implement each of the functions by hardware, software, etc., or any combinations of these.

Embodiments and the modifications can be freely combined, or appropriately modified and omitted.

The foregoing description is in all aspects illustrative and not restrictive. It is understood that numerous modifications that have not yet been exemplified can be devised.

### EXPLANATION OF REFERENCE SIGNS

2 software quality measurement unit, 4 age diagnosis unit, 6 development trend approximate expression calculator, 8 lifetime estimation unit, 10 main unit lifetime extraction unit, 15 lifetime correcting unit, 16 lifetime validity calculator, 20 threshold controller, 22 proficiency level calculator, 24 lifetime cause extraction unit, 26 improvement entry selector, 27 improved lifetime simulator, 101 architecture lifetime estimation apparatus, 201 input unit, 203 data accumulation unit.

1. An architecture lifetime estimation apparatus, comprising:
obtaining circuitry to obtain a source code;
software quality measurement circuitry to measure software quality data values each indicating quality of the source code, based on the source code;
an age calculator to calculate complexity of the source code in a software structure as a diagnosed age of the source code, based on the software quality data values;
a data accumulation storage to accumulate the diagnosed age for each of revisions of the source code;
a development trend approximate expression calculator to calculate, based on the diagnosed age accumulated by the data accumulation storage for each of the revisions, a development trend approximate expression indicating a relationship between the revision and the diagnosed age; and
lifetime estimation circuitry to estimate a lifetime on the revision of the source code, based on the development trend approximate expression,
wherein the architecture lifetime estimation apparatus outputs information based on the lifetime.

2. The architecture lifetime estimation apparatus according to claim 1,
wherein the source code is partitioned per predefined unit,
the software quality measurement circuitry measures the software quality data values for each of the predefined units, based on the source code partitioned per the predefined unit,
the age calculator calculates the diagnosed age for each of the predefined units, based on the software quality data values measured for the predefined unit,
the data accumulation storage accumulates the diagnosed age for each of the revisions and for each of the predefined units,
the development trend approximate expression calculator calculates, based on the diagnosed age accumulated by the data accumulation storage for each of the revisions and for each of the predefined units, the development trend approximate expression for the predefined unit, and
the lifetime estimation circuitry estimates the lifetime for each of the predefined units, based on the development trend approximate expression calculated for the predefined unit.

3. The architecture lifetime estimation apparatus according to claim 2,
wherein the architecture lifetime estimation apparatus outputs information based on the lifetime estimated by the lifetime estimation circuitry for each of the predefined units.

4. The architecture lifetime estimation apparatus according to claim 2, further comprising
main unit lifetime extraction circuitry to extract the lifetime of one of the predefined units, based on an influence of the lifetime estimated by the lifetime estimation circuitry for each of the predefined units on a lifetime of the whole source code,
wherein the architecture lifetime estimation apparatus outputs information based on the lifetime of the one of the predefined units.

5. The architecture lifetime estimation apparatus according to claim 2, further comprising
lifetime correcting circuitry to correct the lifetime for each of the predefined units, based on the lifetimes estimated by the lifetime estimation circuitry for the predefined unit and dependencies between the predefined units.

6. The architecture lifetime estimation apparatus according to claim 2,
wherein the obtaining circuitry further obtains design information indicating an architecture designed in advance for the source code, and
a difference between an architecture of the source code itself and the architecture indicated by the design information is reflected on the lifetime.

7. The architecture lifetime estimation apparatus according to claim 2,
wherein the obtaining circuitry further obtains design information indicating an architecture designed in advance for the source code,
the architecture lifetime estimation apparatus further comprises
a lifetime validity calculator to calculate validity of the lifetime for each of the predefined units, based on a difference between an architecture of the source code itself and the architecture indicated by the design information, and
the architecture lifetime estimation apparatus outputs information based on the validity.

8. The architecture lifetime estimation apparatus according to claim 1,
wherein the obtaining circuitry further obtains malfunction information on the source code, and
the malfunction information is reflected on the lifetime.

9. The architecture lifetime estimation apparatus according to claim 2,
wherein the obtaining circuitry further obtains development prospect information for each of the predefined units,
the architecture lifetime estimation apparatus further comprises
a threshold controller to control an age threshold for each of the predefined units, based on the development prospect information for the predefined unit, and
the lifetime estimation circuitry estimates the lifetime for each of the predefined units, based on the development trend approximate expression and the age threshold.

10. The architecture lifetime estimation apparatus according to claim 1,
wherein the obtaining circuitry further obtains operation information on an operator of the source code,
the architecture lifetime estimation apparatus further comprises
a proficiency level calculator to calculate a proficiency level of the operator, based on the operation information and the diagnosed age accumulated by the data accumulation storage for each of the revisions, and
the lifetime estimation circuitry estimates the lifetime, based on the development trend approximate expression and the proficiency level.

11. The architecture lifetime estimation apparatus according to claim 1,
wherein the data accumulation storage accumulates the software quality data values and metrics extracted by the software quality measurement circuitry from the source code for each of the revisions of the source code,
the architecture lifetime estimation apparatus further comprising
lifetime cause extraction circuitry to extract the metrics and the software quality data values to be causes on whether the lifetime is good or bad, as lifetime causes.

12. The architecture lifetime estimation apparatus according to claim 11, further comprising:
an improvement entry selector to select a part or a whole of lifetime causes that negatively influence the lifetime from among the lifetime causes; and
an improved lifetime simulator to estimate an improved lifetime, based on the development trend approximate expression calculated from the diagnosed age when the lifetime causes selected by the improvement entry selector have been improved.

13. A method of estimating an architecture lifetime, comprising:
obtaining a source code;
measuring software quality data values each indicating quality of the source code, based on the source code;
calculating complexity of the source code in a software structure as a diagnosed age of the source code, based on the software quality data values;
accumulating the diagnosed age for each of revisions of the source code in a data accumulation storage;
calculating, based on the diagnosed age accumulated in the data accumulation storage for each of the revisions, a development trend approximate expression indicating a relationship between the revision and the diagnosed age;
estimating a lifetime on the revision of the source code, based on the development trend approximate expression; and
outputting information based on the lifetime.
